(19) United States
(12) Patent Application Publication
(10) Pub. No.: US 2023/0155108 A1
(43) Pub. Date: May 18, 2023

(54) METHODS FOR MAKING THICK MULTILAYER ELECTRODES

(71) Applicant: GM Global Technology Operations LLC, Detroit, MI (US)

(72) Inventors: Meng JIANG, Rochester Hills, MI (US); Xiaosong HUANG, Novi, MI (US); Marissa Marie KERRIGAN, Berkley, MI (US)

(73) Assignee: GM Global Technology Operations LLC, Detroit, MI (US)

(21) Appl. No.: 17/526,762

(22) Filed: Nov. 15, 2021

(51) Int. Cl. H01M 4/131; H01M 4/1391; H01M 4/66; H01M 10/0525

(52) U.S. Cl. CPC H01M 4/131; H01M 4/1391; H01M 4/667; H01M 4/663; H01M 10/0525

(57) ABSTRACT

Methods of making a thick multilayer electrode for an electrochemical cell that cycles lithium are provided. The methods may include forming the multilayer electrode on a current collector by forming a plurality of electrode units to define an electrode stack on the current collector. Each unit of the plurality of electrode units comprises an electroactive material layer comprising a plurality of electroactive particles and an interfacial conductive material layer comprising a plurality of graphene nanoparticles. The electrode stack has a thickness of greater than or equal to about 100 micrometers and is capable of winding and withstanding a bend angle of greater than or equal to a radius of curvature of less than or equal to about 1 radian/inch while remaining substantially free of macrocracks.

### INTRODUCTION

This section provides background information related to the present disclosure which is not necessarily prior art.

The present disclosure relates to methods for making thick multilayered electrodes that are capable of withstanding rolling or winding without suffering from damage, such as macrocracking.

Electrodes for lithium ion batteries or electrical cells may have a high loading density of electroactive materials to increase overall cell energy density. For example, thicker electroactive material layers and/or greater loading of electroactive materials increases a relative amount of electroactive materials relative to inert materials present in the electrochemical cell, such as current collectors and separators. However, electroactive material layers for electrodes are usually limited to thicknesses of less than about 100 micrometers (μm) or so, due to difficulties in processing and applying slurries, along with cracking and other defects that often arise when thicker electrode materials are formed by slurry casting. For example, during slurry casting and fabrication, stress caused by volumetric shrinkage of the electrode slurry from drying leads to electrode fracture and delamination.

Further, thick electrodes may crack during drying and winding processes because of stress in the electrode's structure. As many electrode and battery components are processed in roll-to-roll manufacturing, electrode layers are wound or rolled onto a spool and thus undergo the physical stress of winding at tight angles that further promotes breakage of thicker electrodes. Thus, many electrode active layers having thicknesses greater than 100 μm are observed to not only have macrocracking that is visible to an observer, but further are often observed to delaminate, easily separating or peeling from the current collector. For any given colloidal dispersion of electrode active material, there is a breakpoint with increasing thickness from crack free to cracked, which can potentially diminish electrode mechanical integrity and battery life. This breaking point is referred to as a critical cracking thickness (CCT). As such, electrochemical performance may be compromised by the lack of structural integrity of thick electrodes, which deteriorate the life and power/fast charging performance. Thus, electrode thickness has a significant impact on the rate performance of batteries, due to low electronic and ionic conductivity when damage is incurred.

Thus, it would be desirable to form thick electrodes (e.g., thick positive electrodes/cathodes or negative electrodes/anodes) that may be processed in typical manufacturing processes, including rolling, for electrochemical cells or batteries incorporating, while overcoming the CCT and providing higher energy density to increase storage capacity and/or reduce the size of the battery, while maintaining a similar cycle life as other lithium ion batteries.

### SUMMARY

This section provides a general summary of the disclosure, and is not a comprehensive disclosure of its full scope or all of its features.

The present disclosure relates to a method of making a thick multilayer electrode for an electrochemical cell that cycles lithium. The method includes forming the multilayer electrode on a current collector by forming a plurality of electrode units to define an electrode stack on the current collector. Each unit of the plurality of electrode units includes an electroactive material layer and an interfacial conductive layer. The electroactive material layer includes a plurality of electroactive particles. The interfacial conductive material layer includes a plurality of graphene nanoparticles. The electrode stack has a thickness of greater than or equal to about 100 micrometers and is capable of winding and withstanding a radius of curvature of less than or equal to about 1 radian/inch while remaining substantially free of macrocracks.

In certain aspects, the forming the plurality of electrode units further includes applying a first precursor of the electroactive material layer to a target surface. Then, a second precursor of the interfacial conductive material layer is applied over the first precursor to form a first electrode unit. The method further includes repeating the applying of the first precursor and the applying of the second precursor over the first electrode unit to form a second electrode unit.

In certain aspects, the forming the plurality of electrode units further includes applying a first precursor of the interfacial conductive material layer to a target surface, then applying a second precursor of the electroactive material layer over the first precursor to form a first electrode unit, then repeating the applying of the first precursor and the applying of the second precursor over the first electrode unit to form a second electrode unit.

In certain aspects, the electrode stack includes at least 5 electrode units.

In certain aspects, the graphene nanoparticles are selected from the group consisting of: graphene nanoplatelets, graphene monolayer sheets, graphene bilayer sheets, graphene superlattices, graphene nanoribbons, graphene fibers, three-dimensional graphene pillars, reinforced graphene, graphene nanocoils, graphene aerogels, graphene foam, exfoliated graphene nanoplatelets, chlorographene, fluorographene, graphexeter, graphene oxide, and combinations thereof.

In certain aspects, the electroactive material layer has a thickness of greater than or equal to about 5 μm to less than or equal to about 100 μm and the interfacial conductive material layer has a thickness of less than or equal to about 5 μm.

In certain aspects, the thickness of the electrode stack is greater than or equal to about 100 micrometers to less than or equal to about 450 micrometers.

In certain aspects, the plurality of graphene nanoparticles includes graphene nanoplatelets and the interfacial conductive material layer is formed by solidifying a slurry precursor of the interfacial conductive material that includes greater than or equal to about 80 weight % and less than 99.5 weight % of graphene nanoplatelets, greater than or equal to about 0.5 weight % to less than or equal to about 20 weight % of a binder, and a balance solvent.

In certain aspects, the electroactive material layer is formed by solidifying a slurry precursor of the electroactive material layer that includes the plurality of electroactive particles at greater than or equal to about 20 weight % to less than or equal to about 80 weight %, a plurality of electrically conductive particles at greater than or equal to about 2 weight % to less than or equal to about 30 weight %, and a binder at greater than or equal to about 2 weight % to less than or equal to about 30 weight % and a balance solvent.

In certain aspects, the forming the plurality of electrode units further includes sequentially applying first slurry precursor of the electroactive material layer or the interfacial conductive material layer via a coating die to a target surface followed by applying a second slurry precursor of the other of the electroactive material layer and the interfacial conductive material layer in a sequential layer-by-layer application process to form the electrode unit.

In certain aspects, the forming of the plurality of electrode units further includes concurrently applying a first slurry precursor of the electroactive material layer or the interfacial conductive material layer and a second slurry precursor of the other of the electroactive material layer and the interfacial conductive material layer via a coating die to a target surface to form the electrode unit.

In certain aspects, the forming the plurality of electrode units further includes first applying a first precursor of the electroactive material layer or the interfacial conductive material layer via a first dry printer sprayer and applying a second precursor of the other of the electroactive material layer or the interfacial conductive material layer via a second dry printer sprayer to form the electrode unit.

The present disclosure also contemplates another method of making a layered thick electrode for an electrochemical cell that cycles lithium. The method includes forming an electrode stack including: (i) applying a first precursor of either of (a) an electroactive material layer or (b) an interfacial conductive material layer including a plurality of graphene nanoplatelets to a current collector to form a first layer; (ii) applying a second precursor of the other of (a) the electroactive material layer or (b) the interfacial conductive material layer including a plurality of graphene nanoplatelets over the first layer to form a second layer, (iii) applying the first precursor over the second layer to form a third layer; and (iv) applying the second precursor over the fourth layer. In this manner, an electrode stack is formed having a plurality of alternating layers including the first layer, the second layer, the third layer, and the fourth layer. The electrode stack has a thickness of greater than or equal to about 100 micrometers and is capable of winding and withstanding a radius of curvature of less than or equal to about 1 radian/inch while remaining substantially free of macrocracks.

In certain aspects, the first precursor or the second precursor forms the interfacial conductive material and includes greater than or equal to about 80 weight % and less than 99.5 weight % of graphene nanoplatelets, greater than or equal to about 0.5 weight % to less than or equal to about 20 weight % of a binder, and a balance solvent.

In certain aspects, the first precursor or the second precursor forms the electroactive material layer and includes a plurality of electroactive particles at greater than or equal to about 20 weight % to less than or equal to about 80 weight %, a plurality of electrically conductive particles at greater than or equal to about 2 weight % to less than or equal to about 30 weight %, and a binder at greater than or equal to about 2 weight % to less than or equal to about 30 weight % and a balance solvent.

In certain aspects, the (i) applying the first precursor, (ii) applying the second precursor, (iii) applying the first precursor, and (iv) applying the second precursor each occur by sequentially passing through a coating die to a target surface in a layer-by-layer application process to form the electrode stack.

In certain aspects, the (i) applying the first precursor and (ii) applying the second precursor occur concurrently by passing the first precursor in the form of a slurry and the second precursor in the form of a slurry through a coating die that applies the first precursor and the second precursor to a target surface to form the first layer and the second layer in the electrode stack. The (iii) applying the first precursor and (iv) applying the second precursor occur concurrently by passing the first precursor in the form of a slurry and the second precursor in the form of a slurry through a coating die that applies the first precursor and the second precursor to a target surface to form the third layer and the fourth layer in the electrode stack.

In certain aspects, the (iii) applying the first precursor and (iv) applying the second precursor are repeated to form a plurality of alternating third layers and fourth layers in the electrode stack.

In certain aspects, the (i) applying the first precursor, (ii) applying the second precursor, (iii) applying the first precursor, and (iv) applying the second precursor each occur via an independent dry printer sprayer to form the electrode stack.

The present disclosure further contemplates a method of making a layered thick positive electrode for an electrochemical cell that cycles lithium. The method includes forming a positive electrode stack on a current collector including: (i) applying a first precursor including a plurality of positive electroactive particles to form a positive electroactive material layer including the plurality of positive electroactive particles. The positive electroactive particles include a material selected from the group consisting of: lithium manganese oxide, lithium manganese nickel oxide, lithium nickel manganese cobalt oxide, lithium nickel manganese cobalt aluminum oxide, lithium iron phosphate, lithium manganese iron phosphate, lithium silicate, and combinations thereof. The method also includes (ii) applying a second precursor comprising a plurality of graphene nanoplatelets over the positive electroactive material layer to form an interfacial conductive material layer including the plurality of graphene nanoplatelets. The method includes repeating (i) and (ii) so as to form an electrode stack having a plurality of alternating positive electroactive material layers and interfacial conductive material layers. The positive electrode stack that is formed has a thickness of greater than or equal to about 100 micrometers and that is capable of winding and withstanding a radius of curvature of less than or equal to about 1 radian/inch while remaining substantially free of macrocracks.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic illustration of an electrochemical battery cell for cycling lithium ions;

FIG. 2 is a side sectional view of a multilayered electrode formed in accordance with certain aspects of the present disclosure;

FIG. 3 is an illustration of a graphene nanoplatelet used to form a positive electrode in accordance with certain aspects of the present disclosure;

FIG. 4 is a perspective illustration of a rolling process for manufacturing a battery showing bending angle for a multilayer electrode;

FIG. 5 is an illustration of a method for forming a thick multilayer electrode film precursor in a sequential die coating process according to various aspects of the present disclosure;

FIG. 6 is an illustration of a method for forming a thick multilayer electrode film precursor in a concurrent die coating process according to various aspects of the present disclosure; and

FIG. 7 is an illustration of a dry spraying method for forming a thick multilayer electrode film precursor in a sequential dry spraying process according to various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure provides methods of making high-quality thick electrodes for electrochemical cells that are flexible and capable of being wound without suffering from damage. In particular, the present disclosure provides methods of making high-quality thick electrodes, such as positive electrodes, that are free of significant structural defects, such as macrocracks, even when subjected to significant bend angles and forces associated with winding (e.g., being wound in a battery or during manufacturing on a roll or spool). Macrocracks are generally those that are large enough to be observed by the human eye. As will be described further herein, the present methods form a multilayered electrode with includes a plurality of electrode units disposed on a current collector. Each electrode unit comprises an electroactive material layer and an interfacial conductive material layer comprising graphene, which when assembled as electrode units create alternating layers that can facilitate a thick electrode with good electrochemical performance, while having the ability to relieve winding stresses by the presence of the interfacial conductive material layer comprising graphene that permits sliding between respective electroactive material layers.

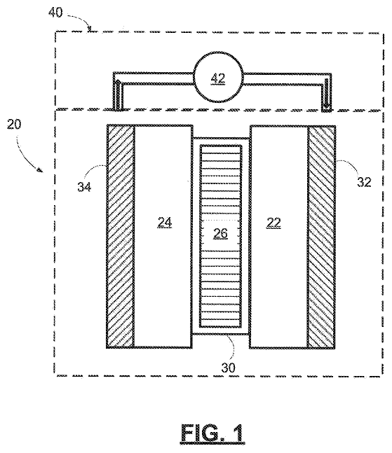

By way of background, an exemplary and schematic illustration of an electrochemical cell (also referred to as a battery) 20 is shown in FIG. 1. Although the illustrated examples include a single positive electrode or cathode and a single negative electrode or anode, the skilled artisan will recognize that the present disclosure also contemplates various other configurations, including those having one or more cathodes and one or more anodes, as well as various current collectors with electroactive layers disposed on or adjacent to one or more surfaces thereof.

A typical lithium-ion battery 20 includes a first electrode (such as a negative electrode 22 or anode) opposing a second electrode (such as a positive electrode 24 or cathode) and a separator 26 and/or electrolyte 30 disposed therebetween. While not shown, often in a lithium-ion battery pack, batteries or cells may be electrically connected in a stack or winding configuration to increase overall output. Lithium-ion batteries operate by reversibly passing lithium ions between the first and second electrodes. For example, lithium ions may move from the positive electrode 24 to the negative electrode 22 during charging of the battery, and in the opposite direction when discharging the battery. The electrolyte 30 is suitable for conducting lithium ions and may be in liquid, gel, or solid form.

When a liquid or semi-liquid/gel electrolyte is used, the separator 26 (e.g., a microporous polymeric separator) is thus disposed between the two electrodes 22, 24 and may comprise the electrolyte 30, which may also be present in the pores of the negative electrode 22 and positive electrode 24. When a solid electrolyte is used, the microporous polymeric separator 26 may be omitted. The solid-state electrolyte may also be mixed into the negative electrode 22 and the positive electrode 24. A negative electrode current collector 32 may be positioned at or near the negative electrode 22 and a positive electrode current collector 34 may be positioned at or near the positive electrode 24. An interruptible external circuit 40 and a load device 42 connects the negative electrode 22 (through its current collector 32) and the positive electrode 24 (through its current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions that are also produced at the negative electrode 22 are concurrently transferred through the electrolyte 30 contained in the separator 26 towards the positive electrode 24. The electrons flow through the external circuit 40 and the lithium ions migrate across the separator 26 containing the electrolyte solution 30 to form intercalated lithium at the positive electrode 24. As noted above, electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of transition metal ions, at the positive electrode 24 so that electrons and lithium ions are produced. The lithium ions flow from the negative electrode 22 through the electrolyte 30 across the separator 26 to replenish the positive electrode 24 with lithium for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, the separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. The negative electrode current collector 32 and positive electrode current collector 34 respectively collect and move free electrons to and from an external circuit 40.

Further, as noted above, when a liquid or semi-liquid electrolyte is used, the separator 26 operates as an electrical insulator by being sandwiched between the negative electrode 22 and the positive electrode 24 to prevent physical contact and thus, the occurrence of a short circuit. The separator 26 provides not only a physical and electrical barrier between the two electrodes 22, 24, but also contains the electrolyte solution in a network of open pores during the cycling of lithium ions, to facilitate functioning of the battery 20. The solid-state electrolyte layer may serve a similar ion conductive and electrically insulating function, but without needing a separator 26 component.

The battery 20 can include a variety of other components that while not depicted here are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the battery 20 may also be a solid-state battery that includes a solid-state electrolyte that may have a different design, as known to those of skill in the art.

Electrodes can generally be incorporated into various commercial battery designs, such as prismatic shaped cells, wound cylindrical cells, coin cells, pouch cells, or other suitable cell shapes. The cells can include a single electrode structure of each polarity or a stacked structure with a plurality of positive electrodes and negative electrodes assembled in parallel and/or series electrical connections. In particular, the battery can include a stack of alternating positive electrodes and negative electrodes with separators disposed therebetween. While the positive electroactive materials can be used in batteries for primary or single charge use, the resulting batteries generally have desirable cycling properties for secondary battery use over multiple cycling of the cells.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

The present technology pertains to making improved electrochemical cells, especially lithium-ion batteries. In various instances, such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran, 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous separator membranes 26 include CELGARD° 2500 (a monolayer polypropylene separator) and CELGARD° 2320 (a trilayer polypropylene/polyethylene/polypropylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: NOMEX™ aramid, ARAMID polyamide, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26.

In various aspects, the porous separator 26 and the electrolyte 30 in FIG. 1 may be replaced with a solid-state electrolyte (SSE) (not shown) that functions as both an electrolyte and a separator. The SSE may be disposed between the positive electrode 24 and negative electrode 22. The SSE facilitates transfer of lithium ions, while mechanically separating and providing electrical insulation between the negative and positive electrodes 22, 24. The SSE may be a solid-state inorganic compound or a solid-state polymer electrolyte. By way of non-limiting example, SSEs may include LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, polyethylene oxide (PEO) based polymers, polycarbonates, polyesters, polynitriles (e.g., polyacrylonitrile (PAN)), polyalcohols (e.g., polyvinyl alcohol (PVA)), polyamines (e.g., polyethyleneimine (PEI)), polysiloxane (e.g., polydimethylsiloxane (PDMS)) and fluoropolymers (e.g., polyvinylidene fluoride (PVdF), polyvinylidene fluoride-hexafluoropropylene (PVDF-HFP)), bio-polymers like lignin, chitosan and cellulose, and any combinations thereof.

The negative electrode 22 includes an electroactive material this is a lithium host material capable of functioning as a negative terminal of a lithium ion battery. The negative electrode 22 may be formed from a lithium host material that is capable of functioning as a negative terminal of a lithium-ion battery. The negative electrode 22 may be a layer of the negative electroactive material or may be a porous electrode composite and include the negative electrode active material and, optionally, an electrically conductive material or other filler, as well as one or more polymeric binder materials to structurally hold the lithium host electroactive material particles together.

In certain variations, the negative electrode 22 is a film or layer formed of a negative electroactive material, such as graphite, lithium-silicon and silicon containing binary and ternary alloys and/or tin-containing alloys, such as Si—Sn, SiSnFe, SiSnAl, SiFeCo, SnO₂, lithium metal, alloys of lithium metal, and the like. In certain alternative embodiments, lithium-titanium anode materials are contemplated, such as Li₄₊ₓTi₅O₁₂, where 0≤x≤3, including lithium titanate (Li₄Ti₅O₁₂) (LTO). Thus, negative electroactive materials for the negative electrode 22 may be selected from the group consisting of: lithium, graphite, silicon, silicon-containing alloys, tin-containing alloys, and combinations thereof.

Such negative electrode active materials may be optionally intermingled with an electrically conductive material that provides an electron conduction path and/or at least one polymeric binder material that improves the structural integrity of the negative electrode 22. By way of non-limiting example, the negative electrode 22 may include an active material including electroactive material particles (e.g., graphite particles) intermingled with a polymeric binder material. The polymeric binder material may be selected from the group consisting of polyvinylidene fluoride (PVDF), polytetrafluoroethylene (PTFE), ethylene propylene diene monomer (EPDM) rubber, carboxymethoxyl cellulose (CMC), nitrile butadiene rubber (NBR), lithium polyacrylate (LiPAA), sodium polyacrylate (NaPAA), polyacrylic acid, polytetrafluoroethylene (PTFE), polyethylene (PE), polyamide, polyimide, sodium alginate, lithium alginate, and combinations thereof, by way of example.

Additional suitable electrically conductive materials may include carbon-based materials or a conductive polymer. Carbon-based materials may include, by way of non-limiting example, particles of KETCHEN™ black, DENKA™ black, acetylene black, carbon black, graphene, carbon nanotubes, carbon nanofibers, and the like. Conductive metal particles may include nickel, gold, silver, copper, aluminum, and the like. Examples of a conductive polymer include polyaniline, polythiophene, polyacetylene, polypyrrole, and the like. In certain aspects, mixtures of conductive materials may be used.

A composite negative electrode may comprise the negative electrode active material present at greater than about 60 wt. % of the overall weight of the electroactive material of the electrode (not including the weight of the current collector), optionally greater than or equal to about 65 wt. %, optionally greater than or equal to about 70 wt. %, optionally greater than or equal to about 75 wt. %, optionally greater than or equal to about 80 wt. %, optionally greater than or equal to about 85 wt. %, optionally greater than or equal to about 90 wt. %, and in certain variations, optionally greater than or equal to about 95% of the overall weight of the electroactive material layer of the electrode.

The binder may be present in the negative electrode 22 at greater than or equal to about 1 wt. % to less than or equal to about 20 wt. %, optionally greater than or equal to about 1 wt. % to less than or equal to about 10 wt. %, optionally greater than or equal to about 1 wt. % to less than or equal to about 8 wt. %, optionally greater than or equal to about 1 wt. % to less than or equal to about 7 wt. %, optionally greater than or equal to about 1 wt. % to less than or equal to about 6 wt. %, optionally greater than or equal to about 1 wt. % to less than or equal to about 5 wt. %, or optionally greater than or equal to about 1 wt. % to less than or equal to about 3 wt. % of the total weight of the electroactive material layer of the electrode.

In certain variations, the negative electrode 22 includes the electrically-conductive material at less than or equal to about 20 wt. %, optionally less than or equal to about 15 wt. %, optionally less than or equal to about 10 wt. %, optionally less than or equal to about 5 wt. %, optionally less than or equal to about 1 wt. %, or optionally greater than or equal to about 0.5 wt. % to less than or equal to about 8 wt. % of the total weight of the electroactive material layer of the negative electrode. While the electrically conductive materials may be described as powders, these materials can lose their powder-like character following incorporation into the electrode, where the associated particles of the supplemental electrically conductive materials become a component of the resulting electrode structure.

The negative electrode current collector 32 can comprise metal, for example, it may be formed from copper (Cu), nickel (Ni), or alloys thereof or any other appropriate electrically conductive material known to those of skill in the art.

In certain aspects, the negative electrode current collector 32 and/or positive electrode current collector (discussed below) may be in the form of a foil, slit mesh, expanded metal a metal grid or screen, and/or woven mesh. Expanded metal current collectors refer to metal grids with a greater thickness such that a greater amount of electrode active material is placed within the metal grid.

In various aspects, the positive electrode 24 may include a positive electroactive material, like a lithium-based electroactive material, which can sufficiently undergo lithium intercalation and deintercalation, or alloying and dealloying, while functioning as the positive terminal of the battery. One exemplary common class of known materials that can be used to form the electroactive material layer of the positive electrode is layered lithium transitional metal oxides. For example, in certain aspects, the positive electrode may comprise one or more materials having a spinel structure, such as lithium manganese oxide (Li₍₁₊ₓ₎Mn₂O₄, where 0.1≤x≤1, abbreviated LMO), lithium manganese nickel oxide (LiMn₍₂₋ₓ₎NiₓO₄, where 0≤x≤0.5, abbreviated LMNO) (e.g., LiMn_{1.5}Ni_{0.5}O₄), a lithium iron polyanion oxide with olivine structure, such as lithium iron phosphate (LiFePO₄, abbreviated LFP), or other phosphate based actives, like lithium manganese-iron phosphate (LiMn₂₋ₓFeₓPO₄, where 0≤x≤0.3, abbreviated LMFP), lithium iron fluorophosphate (Li₂FePO₄F), one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1, abbreviated NMC) (e.g., LiMn_{0.33}Ni_{0.33}Co_{0.33}O₂), a lithium nickel manganese cobalt aluminum oxide, such as Li(Ni_{0.89}Mn_{0.05}Co_{0.05}Al_{0.01})O₂ (abbreviated NCMA), a lithium nickel cobalt metal oxide (LiNi_{(1-x-y)}CoₓM_{y}O₂, where 0<x<0.2, y<0.2, and M may be Al, Mg, Ti, or the like), or lithium silicate based materials, like orthosilicates, Li₂MSiO₄ (where M═Mn, Fe, and Co) or silicides, like Li₆MnSi₅, and any combinations thereof.

In certain variations, the positive electroactive materials may be doped (for example, by magnesium (Mg)) or have a coating disposed over each particle surface. For example, the coating may be a carbon containing, oxide containing (e.g., aluminum oxide), fluoride containing, nitride containing or polymeric thin coating disposed over the electroactive material. The coating may be ionically conductive and optionally electrically conductive. The coating may also be applied over the composite electrode (electroactive material layer) after formation in alternative variations. The positive electroactive materials may be particulate or powder compositions. The positive electroactive material particles may be intermingled with the polymeric binder and electrically conductive materials, like those described above in the context of the negative electrode 22. Similar amounts of positive electroactive material particles, electrically conductive materials, and binder may be used as described above in the context of the negative electroactive material particles and other components of the negative electrode 22 and for brevity will not be repeated herein.

The positive electrode current collector 34 may be formed from aluminum or any other appropriate electrically conductive material known to those of skill in the art. It may have any of the forms described above in the context of the negative electrode current collector 32.

A porosity of the composite electroactive material layer, whether the negative electrode 22 or positive electrode 24 after all processing is completed (including consolidation and calendering) may considered to be a fraction of void volume defined by pores over the total volume of the electroactive material layer. The porosity may be greater than or equal to about 15% by volume to less than or equal to about 50% by volume, optionally greater than or equal to 20% by volume to less than or equal to about 40% by volume, and in certain variations, optionally greater than or equal to 25% by volume to less than or equal to about 35% by volume.

In certain aspects of the present disclosure, at least one of the positive electrode 24 and the negative electrode 22 is modified in accordance with certain principles of the present teachings. For example, the present disclosure provides a thick battery electrode that utilizes a multilayer design. Relative to electrodes with a single active layer, this design provides a stronger electrode, improves battery energy output, improves electrical conductivity, minimizes or prevents physical damage and cracking, and results in improved cycling stability and lifetime. The electrode is optionally at least one of a negative electrode or a positive electrode in a battery for powering, for example, a battery electric vehicle (BEV), a plug-in hybrid electric vehicle (PHEV), or a hybrid electric vehicle (HEV).

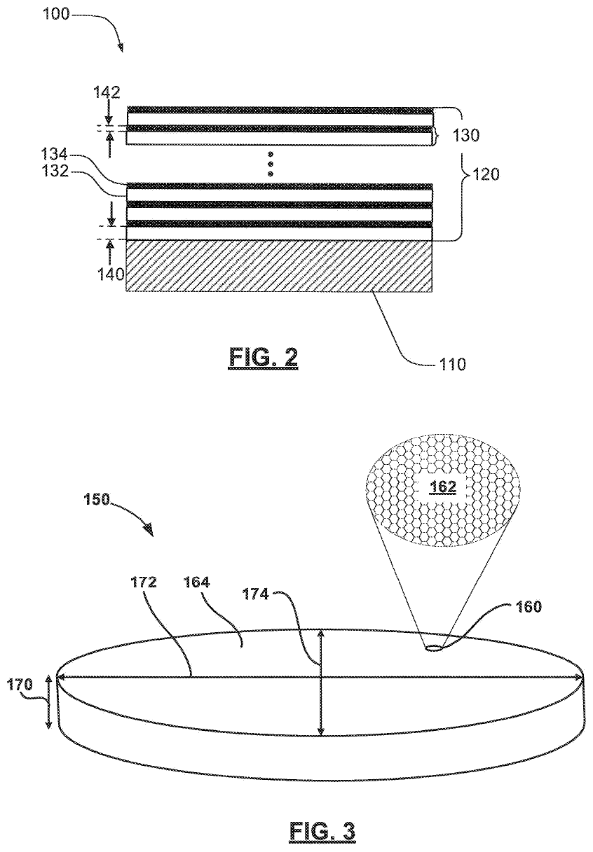

In various aspects, the present disclosure contemplates methods of making thick electrodes for an electrochemical cell that cycles lithium that are bendable or windable and less susceptible to physical damage. The thick electrodes are multilayer electrodes, either positive or negative electrodes. FIG. 2 shows an example of such a thick electrode 100 includes a multilayer electrode stack 120 disposed on a current collector 110.

By a thick electrode, it is meant that the active material of the electrode—in this case, the multilayer electrode stack 120 of the electrode 100 (an overall thickness of the multilayer electrode stack 120, excluding the current collector 110)—has a thickness of greater than or equal to about 100 micrometers (μm), optionally greater than or equal to about 125 μm, optionally greater than or equal to about 150 μm, optionally greater than or equal to about 175 μm, optionally greater than or equal to about 200 μm, optionally greater than or equal to about 225 μm, optionally greater than or equal to about 250 μm, optionally greater than or equal to about 275 μm, and in certain variations, optionally greater than or equal to about 300 μ. In certain variations, a thickness of the multilayer electrode stack 120 may be greater than or equal to about 150 μm to less than or equal to about 2,000 μm, optionally greater than or equal to about 150 μm to less than or equal to about 1,000 μm, optionally greater than or equal to about 150 μm to less than or equal to about 500 μm, and in certain variations optionally greater than or equal to about 150 μm to less than or equal to about 450 μm. In certain variations, the thickness of the electrode may be greater than or equal to about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1,000 μm, about 1,250 μm, about 1,500 μm, or about 1,750 μm.

In one aspect, the method includes forming the multilayer electrode stack 120 on a current collector 110 by forming a plurality of electrode units 130 to define an electrode stack that corresponds to the multilayer electrode stack 120 on the current collector 110. Each unit of the plurality of electrode units 130 comprises an electroactive material layer 132 and an interfacial conductive material layer 134. The electroactive material layer 132 comprises a plurality of electroactive particles, like the positive or negative electroactive materials described above.

The interfacial conductive material layer 134 comprises graphene. In certain variations, the graphene may be a plurality of graphene nanoparticles. In certain aspects, the graphene nanoparticles are selected from the group consisting of: graphene nanoplatelets, graphene monolayer sheets, graphene bilayer sheets, graphene superlattices, graphene nanoribbons, graphene fibers, three-dimensional graphene pillars, reinforced graphene, graphene nanocoils, graphene aerogels, graphene foam, exfoliated graphene nanoplatelets, chlorographene, fluorographene, graphexeter (graphene sheets with interleaved layers of ferric chloride), graphene oxide, and combinations thereof. The interfacial conductive material may also comprise a polymeric binder in certain variations. The polymeric binder in serves as a matrix in which the solid particles (e.g., graphene nanoplatelets) are distributed. In other variations, the interfacial conductive material layer 134 may comprise a layer of graphene that may be deposited by physical vapor deposition (PVD), chemical vapor deposition (CVD), atomic layer deposition (ALD), and the like. In such an alternative variation, interfacial conductive material layer 134 may comprise predominantly graphene, for example, greater than 99% by weight graphene.

In certain variations, the graphene nanoparticles are graphene nanoplatelets. FIG. 3 shows an illustration of an example of one such graphene nanoplatelet 150. The graphene nanoplatelet 150 is formed from at least one sheet of graphene. For example, the graphene nanoplatelet 150 may comprise stacks of graphene sheets having a platelet or planar shape. A hexagonal lattice 162 of carbon atoms forming graphene is shown in the detailed region 160 of surface 164 of the graphene nanoplatelet 150. Each sheet within the graphene nanoplatelet 150 is formed of the two-dimensional hexagonal lattice 162. Each graphene nanoplatelet 150 may have a structure with a height 170, and a major elongate dimension (like length 172), and a second elongate dimension (like width 174). In certain aspects, the nanoplatelets 150 have high aspect ratios with regard to length to height (or width to height), so that a platelet or planar microparticle shape is formed. For example, an aspect ratio may be defined as AR=H/L, where H and L are the height and the length (or alternatively width) of the nanoparticle. An AR of the nanoplatelets 150 may be greater than or equal to about 2, optionally greater than or equal to about 5, optionally greater than or equal to about 10, optionally greater than or equal to about 15, optionally greater than or equal to about 20, optionally greater than or equal to about 25, optionally greater than or equal to about 50, and in certain aspects, optionally greater than or equal to about 100.

In certain variations, the height 170 may be greater than or equal to about 5 nm to less than or equal to about 5 μm. The major dimension or length 172 may be greater than or equal to about 15 nm to less than or equal to about 100 μm. In certain aspects, the nanoplatelets 150 advantageously provide a lower surface area than other traditional conductive particles, such as spherical or fibrous/tubular particles. Moreover, it is believed that the nanoplatelets in particular due to their aspect ratio and physical surface properties provide the ability to facilitate sliding and relieve stress between electroactive material layers in the multilayer electrode stack.

With renewed reference to FIG. 2, as the plurality of electrode units 130 are stacked onto one another, they form a thick electrode stack of alternating electroactive material and interfacial conductive material layers 132, 134 that defines the multilayer electrode stack 120. In certain aspects, the multilayer electrode stack 120 comprises at least 5 electrode units (130), optionally at least 6 electrode units, optionally at least 7 electrode units, optionally at least 8 electrode units, optionally at least 9 electrode units, and in certain variations, optionally at least 10 electrode units. In certain aspects, a multilayer electrode stack/multilayer electrode stack 120 may comprise from 5 to 20 electrode units, optionally from 5 to 15 electrode units, and in certain variations, optionally from 5 to 10 electrode units.

Each electroactive material layer 132 may have a thickness designated as 140 of greater than or equal to about 5 micrometers (μm) to less than or equal to about 150 μm, optionally greater than or equal to about 10 μm to less than or equal to about 100 μm, greater than or equal to about 25 μm to less than or equal to about 75 μm, greater than or equal to about 30 μm to less than or equal to about 60 μm, or greater than or equal to about 40 μm to less than or equal to about 50 μm.

Each interfacial conductive material layer 134 may have a thickness designated 142 of less than or equal to about 5 μm, optionally less than or equal to about 4 μm, optionally less than or equal to about 3 μm, and optionally less than or equal to about 2 μm. In certain variations, each interfacial conductive material layer 134 may have a thickness of greater than or equal to about 1 μm to less than or equal to about 5 μm, optionally greater than or equal to about 2 μm to less than or equal to about 4 μm.

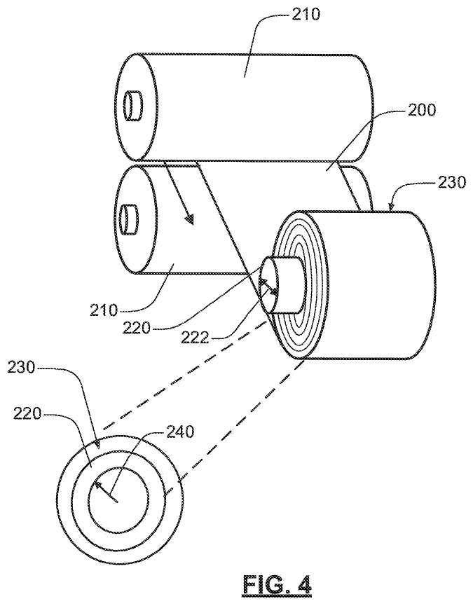

FIG. 4 shows an example of an electrode material 200 like that formed in accordance with the present disclosure being processed in part of a typical roll-to-roll process. The electrode material 200 may be a continuous material that can be processed upstream with applying and processing precursors of the interfacial conductive material layers and electroactive material layers on a continuous current collector. The electrode material 200 may then processed by rolling it onto a spindle, core, or spool 220. The spool 220 may have a diameter shown as 222. The electrode material 200 is thus wrapped onto the spool 220 and can be transported as a roll 230 for later processing, like cutting and assembly. The electrode material 200 may thus be subjected to a bend or curvature depending on the diameter 222 of the spool 220 on which it is wrapped.

In accordance with the present disclosure, the thick multilayer electrode stack is capable of winding and withstanding relatively tight bend angles associated with rolling while remaining substantially free of damage, like macrocracks. Thus, the thick multilayer electrode stack is capable of winding and withstanding a radius of curvature of less than or equal to about 1 radian/inch. A curvature (κ) is defined by 1/r, where r is the radius 240 of the spool 220 around which the electrode material 200 is wound. Generally, the larger the radius 240 is, the smaller the curvature (κ) is. For a spool 220 with a 2 inch diameter (1 inch radius 240), the curvature (κ) is 1 radians/inch. Thus, the radius of curvature may be less than or equal to about 1 radian/inch. In certain aspects, the thick electrode or multilayer electrode stack of the present disclosure is capable of withstanding a radius of curvature of less than or equal to about 1 radian/inch, optionally less than or equal to about 0.75 radians/inch, and in certain aspects, optionally less than or equal to about 0.5 radians/inch, while remaining substantially free of macrocracks.

In certain aspects, the methods of the present disclosure provide for forming of the plurality of electrode units by applying a first precursor of either the electroactive material layer or the interfacial conductive material layer to a target surface. The target surface may be a current collector, a previously deposited electrode unit, or a transfer substrate. The first precursor may be processed for solidification, for example, where the first precursor is a slurry containing a solvent/carrier, the method may include drying the slurry to substantially remove the solvent/carrier. In this manner, a first layer (either an electroactive material layer or an interfacial conductive material layer is formed). Next, a second precursor is applied over the first layer. The second precursor may be the other of the electroactive material layer or the interfacial conductive material layer that was applied as the first precursor, so that it forms a distinct second layer over the first layer. Again, the second precursor may be processed for solidification, for example, where the second precursor is a slurry containing a solvent/carrier, the method may include drying the slurry to substantially remove the solvent/carrier. In this manner, the second layer (the other of the electroactive material layer or the interfacial conductive material layer is formed). After the first layer and second layer are formed, the layers may be cured or cross-linked and pressure may be applied to the layers, to form an electrode unit. Thus, the method involves repeating the applying of the first precursor and the applying of the second precursor over the first electrode unit to form a second electrode unit. The electrode units may then be formed sequentially, for example, being applied in layers over the current collector, to define the multilayered electrode stack.

In alternative variations, the plurality of electrode units may have pressure applied to the entire stack/consolidated after they have been assembled. Further, other conventional processing, like annealing, may be done to pairs of layers or to electrode units as assembled.

In certain aspects, the method may include forming the plurality of electrode units by applying a first precursor of the electroactive material layer to a target surface. Then, a second precursor of the interfacial conductive material layer is applied over the first precursor/first layer to form a first electrode unit. In this manner, the first layer contacting the current collector is the electroactive material layer. The method may further include repeating the applying of the first precursor and the applying of the second precursor over the first electrode unit to form a second electrode unit. Multiple electrode units may thus be formed to create the multilayer electrode stack over the current collector.

In certain aspects, the method may include forming the plurality of electrode units by applying a first precursor of the interfacial conductive material layer to a target surface. Then, a second precursor of the electroactive material layer is applied over the first precursor/first layer to form a first electrode unit. In this manner, the first layer contacting the current collector is the interfacial conductive material. The method may further include repeating the applying of the first precursor and the applying of the second precursor over the first electrode unit to form a second electrode unit. Multiple electrode units may thus be formed to create the multilayer electrode stack over the current collector.

In certain aspects, the interfacial conductive material layer is formed by drying or solidifying a slurry precursor of the interfacial conductive material that comprises greater than or equal to about 80 weight % and less than 99.5 weight % of graphene nanoplatelets and greater than or equal to about 0.5 weight % to less than or equal to about 20 weight % of a binder. The solvent or carrier in the slurry precursor can be an aqueous solvent, such as water, or a non-aqueous solvent, such as N-methyl-2-pyrrolidone (NMP). The slurry can be mixed or agitated, and then applied to a substrate. The substrate can be a removable substrate or alternatively a functional substrate, such as a current collector (such as a metallic grid or mesh layer) attached to one side of the electrode film or another previously formed layer of an electrode unit. As noted above, the interfacial conductive material may further be cured or cross-linked, for example, by exposing the layer to heat, actinic (e.g., UV) radiation, and the like. In such a case, the interfacial conductive material may be porous, for example, having a porosity of greater than or equal to about 15% by volume to less than or equal to about 50% by volume, optionally greater than or equal to 20% by volume to less than or equal to about 40% by volume, and in certain variations, optionally greater than or equal to 25% by volume to less than or equal to about 35% by volume. The pores of the interfacial conductive material may be imbibed or filled with electrolyte, such as liquid electrolyte that is also present in the pores of the composite electroactive material layer.

In certain other aspects, the interfacial conductive material comprising graphene may be deposited as a thin layer without binder, for example, via physical vapor deposition (PVD), like magnetron sputtering, chemical vapor deposition (CVD), plasma enhanced CVD, atomic layer deposition (ALD), and the like.

In certain aspects, the electroactive material layer is formed by drying or solidifying a slurry precursor of the electroactive material layer. In certain variations, an electroactive material layer precursor may be made by mixing the electrode active material into a slurry with a polymeric binder compound, a non-aqueous solvent, optionally a plasticizer, and optionally if necessary, electrically conductive particles. The slurry may comprise a plurality of electroactive particles at greater than or equal to about 20 weight % to less than or equal to about 80 weight %, a plurality of conductive particles at greater than or equal to about 2 weight % to less than or equal to about 30 weight %, and a binder at greater than or equal to about 2 weight % to less than or equal to about 30 weight % with a balance of solvent/carrier. The solvent may be a non-aqueous solvent like N-methyl-2-pyrrolidone (NMP).

The slurry can be mixed or agitated, and then applied to a substrate. The substrate can be a removable substrate or alternatively a functional substrate, such as a current collector (such as a metallic grid or mesh layer) attached to one side of the electrode film or another previously formed layer of an electrode unit. In one variation, heat or radiation can be applied to evaporate the solvent from the electrode film, leaving a solid residue. The electrode film may be further consolidated, where heat and pressure are applied to the film to sinter and calendar it. In other variations, the film may be air-dried at moderate temperature to form self-supporting films. If the substrate is removable, then it is removed from the electrode film that is then further laminated to a current collector. With either type of substrate, it may be necessary to extract or remove the remaining plasticizer prior to incorporation into the battery cell.

FIG. 5 shows one variation of a process 300 of forming a thick electrode that includes a multilayer stack. While not shown in FIG. 5, this process may be conducted in a continuous or roll-to-roll operation. The process 300 may include sequentially applying a first slurry precursor 302 of the electroactive material layer 310 to select regions of a target surface or substrate, such as a current collector 312. The first slurry precursor 302 is applied via a coating die 320 that coats surface regions of the surface of the current collector 312. As noted above, the process may involve drying the precursor to remove solvent, where heat, reduced pressure, or radiation may be used. In this manner, the electroactive material layer 310 may be solidified. Next, a second slurry precursor 322 is applied to select regions of the electroactive material layer 310 via the coating die 320. The process may further involve removing solvent and applying heat, radiation, or reducing pressure to dry the second slurry precursor 322 to form the interfacial conductive material layer 324. In alternative variations not shown, the interfacial conductive material layer 324 may be formed via a distinct process, such as PVD, CVD, ALD, or other processes that form a layer of graphene over the electroactive material layer 310. This process may be repeated in a sequential layer-by-layer application process to form each electrode unit that form a thick multilayer stack and thus an electrode film that is capable of being bent or wound and less susceptible to physical damage. The thick electrode films are multilayer electrodes, either positive or negative electrodes, but in certain particular variations, are positive electrodes.

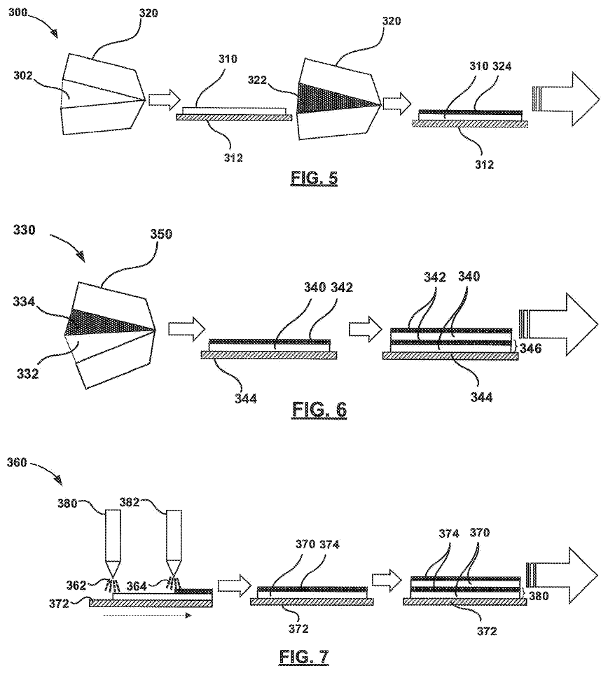

In other aspects, in FIG. 6 a process 330 of forming a thick electrode that includes a multilayer stack includes concurrently applying the layers that form electrode units creating a multilayer electrode stack. While not shown in FIG. 6, this process may be conducted in a continuous or roll-to-roll operation. The process 330 includes concurrently applying a first slurry precursor 332 of the electroactive material layer 340 and a second slurry precursor 334 of the interfacial conductive material layer 342 to select regions of a target surface or substrate, such as a current collector 344. The first slurry precursor 332 and second slurry precursor 334 are applied via a coating die 350 that coats surface regions of the surface of the current collector 344 or other target surface. It should be noted that the coating die 350 may be oriented so as to ensure that one of the first slurry precursor 332 or second slurry precursor 334 is applied first (here the first slurry precursor 332 is applied first). As noted above, the process may involve drying the precursor to remove solvent, where heat, reduced pressure, or radiation may be used. In this manner, the electroactive material layer 340 and the interfacial conductive material layer 342 may be solidified. This process may be repeated to form each electrode unit 346, so that a plurality of the electrode units 346 form a thick multilayer stack and thus an electrode film that is capable of being bent or wound and less susceptible to physical damage. The thick electrode films are multilayer electrodes, either positive or negative electrodes, but in certain particular variations, are positive electrodes.

In yet other process, like a dry printing multilayer coating process 360 shown in FIG. 7, a thick electrode that includes a multilayer electrode stack is generated. Again, while not shown in FIG. 7, this process 360 may be conducted in a continuous or roll-to-roll operation. The process 360 may include sequentially applying a first precursor 362 of an electroactive material layer 370 and a second precursor 364 of an interfacial conductive material layer 374 to select regions of a target surface or substrate, such as a current collector 372. The first precursor 362 may include dry powder or particulates that can be dry sprayed via a first dry printer spray head 380 to surface regions of the surface of the current collector 372. The second precursor 364 may likewise include dry powder or particulates that can be dry sprayed via a second dry printer spray head 382 to surface regions of the electroactive material layer 370 to form the interfacial conductive material layer 374 over it. This process may be repeated in a sequential layer-by-layer application process to form each electrode unit 380 that together form a thick multilayer stack and thus an electrode film that is capable of being bent or wound and less susceptible to physical damage. The thick electrode films are multilayer electrodes, either positive or negative electrodes, but in certain particular variations, are positive electrodes.

Thus, the present disclosure provides methods of making a layered thick electrode for an electrochemical cell that cycles lithium. The method may include forming an electrode stack comprising (i) applying a first precursor of either of (a) an electroactive material layer or (b) an interfacial conductive material layer comprising a plurality of graphene nanoplatelets to a current collector to form a first layer. Next, the method may include (ii) applying a second precursor of the other of (a) the electroactive material layer or (b) the interfacial conductive material layer comprising a plurality of graphene nanoplatelets over the first layer to form a second layer. Then, the method may further include (iii) applying the first precursor over the second layer to form a third layer; followed by (iv) applying the second precursor over the fourth layer. In this manner, an electrode stack having a plurality of alternating layers comprising the first layer, the second layer, the third layer, and the fourth layer is formed. As noted above, the (iii) applying the first precursor and (iv) applying the second precursor may be repeated to form a plurality of alternating third layers and fourth layers in the electrode stack. In certain variations, the electrode is a positive electrode.

The electrode stack has a thickness of greater than or equal to about 100 micrometers as noted above. Further, the electrode stack is capable of winding (being wound around a tight diameter, for example, a spool or spindle having a diameter of 2 to 4 inches) and withstanding a radius of curvature of less than or equal to about 1 radian/inch while remaining substantially free of macrocracks or any of the previously stated radii of curvature.

In certain aspects, the thick electrode is a positive electrode or cathode. Thus, in certain variations, the present disclosure may provide a method of making a layered thick positive electrode for an electrochemical cell that cycles lithium ions. The method may include forming a positive electrode stack on a current collector comprising (i) applying a first precursor comprising a plurality of positive electroactive particles to form a positive electroactive material layer comprising the plurality of positive electroactive particles. Then, the method comprises (ii) applying a second precursor comprising a plurality of graphene nanoplatelets over the positive electroactive material layer to form an interfacial conductive material layer comprising the plurality of graphene nanoplatelets. The method includes repeating (i) and (ii) so as to form an electrode stack having a plurality of alternating positive electroactive material layers and interfacial conductive material layers. The positive electrode stack has a thickness of greater than or equal to about 150 micrometers and that is capable of winding and withstanding a bend angle of less than or equal to about 90° while remaining substantially free of macrocracks.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a thick multilayer electrode for an electrochemical cell that cycles lithium, the method comprising:
forming the thick multilayer electrode on a current collector by forming a plurality of electrode units to define an electrode stack on the current collector, wherein each unit of the plurality of electrode units comprises an electroactive material layer comprising a plurality of electroactive particles and an interfacial conductive material layer comprising a plurality of graphene nanoparticles and the electrode stack has a thickness of greater than or equal to about 100 micrometers and is capable of winding and withstanding a radius of curvature of less than or equal to about 1 radian/inch while remaining substantially free of macrocracks.

2. The method of claim 1, wherein the forming the plurality of electrode units further comprises applying a first precursor of the electroactive material layer to a target surface, then applying a second precursor of the interfacial conductive material layer over the first precursor to form a first electrode unit, then repeating the applying of the first precursor and the applying of the second precursor over the first electrode unit to form a second electrode unit.

3. The method of claim 1, wherein the forming the plurality of electrode units further comprises applying a first precursor of the interfacial conductive material layer to a target surface, then applying a second precursor of the electroactive material layer over the first precursor to form a first electrode unit, then repeating the applying of the first precursor and the applying of the second precursor over the first electrode unit to form a second electrode unit.

4. The method of claim 1, wherein the electrode stack comprises at least 5 electrode units.

5. The method of claim 1, wherein the graphene nanoparticles are selected from the group consisting of: graphene nanoplatelets, graphene monolayer sheets, graphene bilayer sheets, graphene superlattices, graphene nanoribbons, graphene fibers, three-dimensional graphene pillars, reinforced graphene, graphene nanocoils, graphene aerogels, graphene foam, exfoliated graphene nanoplatelets, chlorographene, fluorographene, graphexeter, graphene oxide, and combinations thereof.

6. The method of claim 1, wherein the electroactive material layer has a thickness of greater than or equal to about 5 μm to less than or equal to about 100 μm and the interfacial conductive material layer has a thickness of less than or equal to about 5 μm.

7. The method of claim 1, wherein the thickness of the electrode stack is greater than or equal to about 100 micrometers to less than or equal to about 450 micrometers.

8. The method of claim 1, wherein the plurality of graphene nanoparticles comprises graphene nanoplatelets and the interfacial conductive material layer is formed by solidifying a slurry precursor of the interfacial conductive material layer that comprises greater than or equal to about 80 weight % and less than 99.5 weight % of graphene nanoplatelets, greater than or equal to about 0.5 weight % to less than or equal to about 20 weight % of a binder, and a balance solvent.

9. The method of claim 1, wherein the electroactive material layer is formed by solidifying a slurry precursor of the electroactive material layer that comprises the plurality of electroactive particles at greater than or equal to about 20 weight % to less than or equal to about 80 weight %, a plurality of electrically conductive particles at greater than or equal to about 2 weight % to less than or equal to about 30 weight %, and a binder at greater than or equal to about 2 weight % to less than or equal to about 30 weight % and a balance solvent.

10. The method of claim 1, wherein the forming the plurality of electrode units further comprises sequentially applying first slurry precursor of the electroactive material layer or the interfacial conductive material layer via a coating die to a target surface followed by applying a second slurry precursor of the other of the electroactive material layer and the interfacial conductive material layer in a sequential layer-by-layer application process to form each of the plurality of electrode units.

11. The method of claim 1, wherein the forming the plurality of electrode units further comprises concurrently applying a first slurry precursor of the electroactive material layer or the interfacial conductive material layer and a second slurry precursor of the other of the electroactive material layer and the interfacial conductive material layer via a coating die to a target surface to form each of the plurality of electrode units.

12. The method of claim 1, wherein the forming the plurality of electrode units further comprises first applying a first precursor of the electroactive material layer or the interfacial conductive material layer via a first dry printer sprayer and applying a second precursor of the other of the electroactive material layer or the interfacial conductive material layer via a second dry printer sprayer to form each of the plurality of electrode units.

13. A method of making a layered thick electrode for an electrochemical cell that cycles lithium, the method comprising:
forming an electrode stack comprising:
(i) applying a first precursor of either of (a) an electroactive material layer or (b) an interfacial conductive material layer comprising a plurality of graphene nanoplatelets to a current collector to form a first layer;
(ii) applying a second precursor of the other of (a) the electroactive material layer or (b) the interfacial conductive material layer comprising a plurality of graphene nanoplatelets over the first layer to form a second layer,
(iii) applying the first precursor over the second layer to form a third layer; and
(iv) applying the second precursor over the third layer, so as to form a fourth layer in an electrode stack having a plurality of alternating layers comprising the first layer, the second layer, the third layer, and the fourth layer, wherein the electrode stack has a thickness of greater than or equal to about 100 micrometers and that is capable of winding and withstanding a radius of curvature of less than or equal to about 1 radian/inch while remaining substantially free of macrocracks.

14. The method of claim 13, wherein the first precursor or the second precursor forms the interfacial conductive material layer and comprises greater than or equal to about 80 weight % and less than 99.5 weight % of graphene nanoplatelets, greater than or equal to about 0.5 weight % to less than or equal to about 20 weight % of a binder, and a balance solvent.

15. The method of claim 13, wherein the first precursor or the second precursor forms the electroactive material layer and comprises a plurality of electroactive particles at greater than or equal to about 20 weight % to less than or equal to about 80 weight %, a plurality of electrically conductive particles at greater than or equal to about 2 weight % to less than or equal to about 30 weight %, and a binder at greater than or equal to about 2 weight % to less than or equal to about 30 weight % and a balance solvent.

16. The method of claim 13, wherein the (i) applying the first precursor, (ii) applying the second precursor, (iii) applying the first precursor, and (iv) applying the second precursor each occur by sequentially passing through a coating die to a target surface in a layer-by-layer application process to form the electrode stack.

17. The method of claim 13, wherein the first precursor is a slurry and the second precursor is a slurry, wherein the (i) applying the first precursor and (ii) applying the second precursor occur concurrently by passing the first precursor and the second precursor through a coating die that applies the first precursor and the second precursor to a target surface to form the first layer and the second layer in the electrode stack and the (iii) applying the first precursor and (iv) applying the second precursor occur concurrently by passing the first precursor and the second precursor through a coating die that applies the first precursor and the second precursor to a target surface to form the third layer and the fourth layer in the electrode stack.

18. The method of claim 13, wherein the (iii) applying the first precursor and (iv) applying the second precursor are repeated to form a plurality of alternating third layers and fourth layers in the electrode stack.

19. The method of claim 13, wherein the (i) applying the first precursor, (ii) applying the second precursor, (iii) applying the first precursor, and (iv) applying the second precursor each occur via an independent dry printer sprayer to form the electrode stack.

20. A method of making a layered thick positive electrode for an electrochemical cell that cycles lithium, the method comprising:
forming a positive electrode stack on a current collector comprising:
(i) applying a first precursor comprising a plurality of positive electroactive particles to form a positive electroactive material layer comprising the plurality of positive electroactive particles, wherein the positive electroactive particles comprise a material selected from the group consisting of: lithium manganese oxide, lithium manganese nickel oxide, lithium nickel manganese cobalt oxide, lithium nickel manganese cobalt aluminum oxide, lithium iron phosphate, lithium manganese iron phosphate, lithium silicate, and combinations thereof;
(ii) applying a second precursor comprising a plurality of graphene nanoplatelets over the positive electroactive material layer to form an interfacial conductive material layer comprising the plurality of graphene nanoplatelets; and repeating (i) and (ii) so as to form an electrode stack having a plurality of alternating positive electroactive material layers and interfacial conductive material layers, wherein the positive electrode stack has a thickness of greater than or equal to about 100 micrometers and that is capable of winding and withstanding a radius of curvature of less than or equal to about 1 radian/inch while remaining substantially free of macrocracks.
